(19) United States
(12) Patent Application Publication
(10) Pub. No.: US 2016/0277486 A1
(43) Pub. Date: Sep. 22, 2016

(54) Installation Method and Network Monitoring System

(71) Applicant: COMPAL BROADBAND NETWORKS INC., Taipei City (TW)

(72) Inventor: Kuo-Shin Chen, Hsinchu County (TW)

(21) Appl. No.: 14/749,660

(22) Filed: Jun. 25, 2015

(30) Foreign Application Priority Data
Mar. 16, 2015 (TW) 104108344

(51) Int. Cl. H04L 29/08; H04N 5/225; H04N 5/77; H04W 84/12

(52) U.S. Cl. CPC H04L 67/104; H04W 84/12; H04N 5/225; H04N 5/77

(57) ABSTRACT

An installation method is disclosed. The installation method includes an electronic device establishing a first connection with an IP camera through a peer-to-peer wireless communication protocol; the IP camera transmitting a frame information to the electronic device through the first connection, and connecting to a cloud server through a second connection, to check whether the electronic device registers a registration information related to the IP camera in the cloud server; and the electronic device displaying the frame information after the registration information of the electronic device is confirmed.

### BACKGROUND OF THE INVENTION

1. Field of the Invention

The present invention relates to an installation method and a network monitoring system, and more particularly, to an installation method and a network monitoring system capable of quickly and conveniently installing the network monitoring system.

2. Description of the Prior Art

As technology evolves, an internet protocol camera (IP camera) may connect to cloud servers via internet to provide various information services. For example, an IP camera has been widely deployed in offices, residences, warehouses, etc. An IP camera may provide real-time video services via internet. Users may watch the video captured by the IP camera via, for example, a smart phone, to perform remote video surveillance.

In general, an IP camera has to send the frame captured to the cloud server, and the cloud server further send the frame to the smart phone. The user is then able to watch the video captured by the IP camera on the smart phone. It is time consuming and requires longer waiting time for users. In addition, in the prior art, using the smart phone to configure the connection between the IP camera and the cloud server is complicated. For example, when the IP camera is powered onto perform installation, the IP camera has to operate in an access point (AP) mode of the IP camera, such that the smart phone may connect to the IP camera and send the necessary connection information of the connection between the IP camera and the cloud server to the IP camera. After the IP camera receives the connection information, the IP camera is able to connect to the cloud server. Under a condition that the IP camera connects to the cloud server via an AP of a wireless local area network (WLAN), after the IP camera receives the connection information, the IP camera has to switch to a Wi-Fi mode so as to connect to the cloud server via the AP. Hence, configuring the connection between the IP camera and the cloud server in the prior art is complicated. Therefore, it is necessary to improve the prior art.

### SUMMARY OF THE INVENTION

It is therefore a primary objective of the present invention to provide an installation method and a network monitoring system, to improve over disadvantages of the prior art.

The invention discloses an installation method, utilized in a network monitoring system, the installation method comprising an electronic device establishing a first connection with an internet protocol (IP) camera through a peer-to-peer wireless communication protocol; the IP camera transmitting a frame information to the electronic device through the first connection and connecting to a cloud server through a second connection to check whether the electronic device registers a registration information related to the IP camera in the cloud server ; and the electronic device displaying the frame information after the registration information of the electronic device is confirmed to be registered.

The invention further discloses a network monitoring system, comprising an electronic device ; and an internet protocol (IP) camera, wherein the IP camera is configured to establish a first connection with the electronic device through a peer-to-peer wireless communication protocol, transmit a frame information to the electronic device through the first connection, and connect to a cloud server through a second connection to check whether the electronic device registers a registration information related to the IP camera in the cloud server; wherein the electronic device displays the frame information after the registration information of the electronic device is confirmed to be registered.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network monitoring system according to an embodiment of the present invention.

FIG. 2 is a schematic diagram of an installation process according to an embodiment of the present invention.

### DETAILED DESCRIPTION

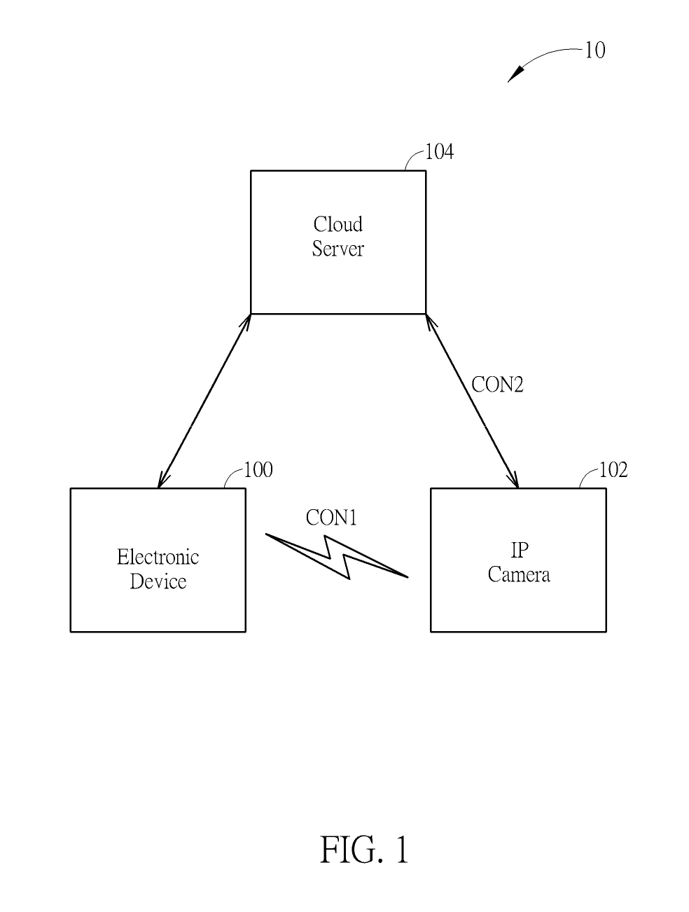

FIG. 1 is a schematic diagram of a network monitoring system 10 according to an embodiment of the present invention. The network monitoring system 10 comprises an electronic device 100 and an internet protocol (IP) camera 102. The electronic device 100 may be an electronic device such as a smart phone, a tablet, etc. The electronic device 100 is utilized for displaying images captured by the IP camera 102. In addition, the electronic device 100 may connect to a cloud server 104 via a wireless connection or a wired connection, so as to register a registration information related to the IP camera 102. The electronic device 100 may establish a first connection CON1 with the IP camera 102. The IP camera 102 may directly send image frame information captured by the IP camera 102 to the electronic device 100 through the first connection CON1, wherein the first connection CON1 is a connection based upon a peer-to-peer wireless communication protocol (e.g., Wi-Fi Direct). In other words, a distance between the electronic device 100 and the IP camera 102 is smaller than a specific distance, and the specific distance is the maximum transmission distance capable of establishing the first connection CON1. In addition, the IP camera 102 may connect to the cloud server 104 through a second connection CON2, so as to check about registration information registered by the electronic device 100.

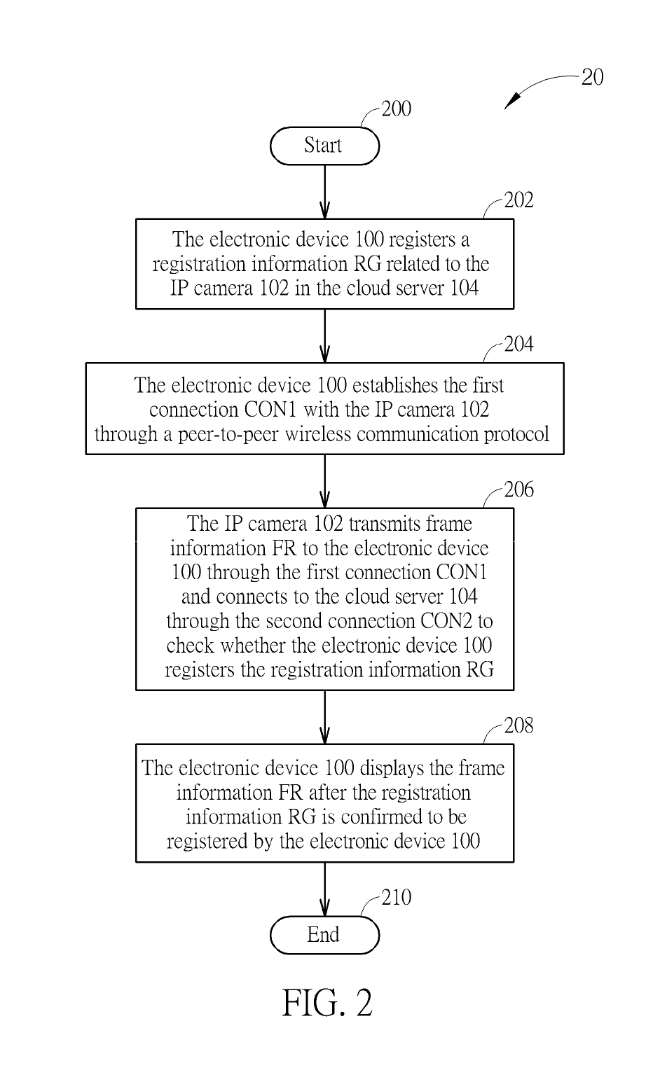

Specifically, please refer to FIG. 2, which is a schematic diagram of an installation process 20 according to an embodiment of the present invention. The installation process 20 may be executed by the network monitoring system 10. As shown in FIG. 2, the installation process 20 comprises following steps:

Step 200: Start.

Step 202: The electronic device 100 registers a registration information RG related to the IP camera 102 in the cloud server 104.

Step 204: The electronic device 100 establishes the first connection CON1 with the IP camera 102 through a peer-to-peer wireless communication protocol.

Step 206: The IP camera 102 transmits frame information FR to the electronic device 100 through the first connection CON1 and connects to the cloud server 104 through the second connection CON2 to check whether the electronic device 100 registers the registration information RG.

Step 208: The electronic device 100 displays the frame information FR after the registration information RG is confirmed to be registered by the electronic device 100.

Step 210: End.

According to the installation process 20, the IP camera 102 may transmit the frame information captured by the IP camera 102 to the electronic device 100 through the first connection CON1 and connect to the cloud server 104 through the second connection CON2. In addition, the frame information FR captured by the IP camera 102 does not have to be passed through the cloud server 104, instead, the frame information FR is transmitted directly to the electronic device 100 through the first connection CON1, significantly reducing waiting time of users.

Specifically, in Step 202, the electronic device 100 may send the registration information RG related to the IP camera 102 to the cloud server 104 through a wireless local area network (WLAN) or a cellular network, so as to perform registration. In Step 204, the electronic device 100 establishes the first connection CON1 with the IP camera 102 through the peer-to-peer wireless communication protocol, wherein the peer-to-peer wireless communication protocol may be Wi-Fi Direct.

In Step 206, after the first connection CON1 is established, the IP camera 102 transmits the frame information FR captured by the IP camera 102 directly to the electronic device 100 through the first connection CON1. At this time moment, the electronic device 100 merely receives and stores the frame information FR. Note that, at this time moment, the electronic device 100 has not obtained permission for displaying the frame information FR, meaning that the user is not able to watch the frame information FR captured by the IP camera 102 via the electronic device 100 yet. In addition, in the meantime, the IP camera 102 connects to the cloud server 104 through the second connection CON2, so as to confirm that the electronic device 100 has registered the registration information RG. In other words, the IP camera 102 may perform both frame transmission and registration confirmation at the same time, so as to save waiting time of the users.

In addition, in an embodiment, the electronic device 100 may transmit connection information related to the second connection CON2 to the IP camera 102 through the first connection CON1 in advance (before the second connection CON2 is established). The connection information related to the second connection CON2 is necessary for the IP camera 102 so as to establish the second connection CON2. The connection information may comprise an internet protocol address (IP Address), subnet mask information, gateway information, primary domain name system (Primary DNS) information, etc. After the IP camera 102 receives the connection information, the IP camera 102 is able to establish the second connection CON2 and connect to the cloud server 104 through the second connection CON2, so as to check whether the electronic device 100 has registered the registration information RG related to the IP camera 102. Furthermore, in an embodiment, the IP camera 102 may connect to the cloud server 104 through an AP of the WLAN. The electronic device 100 may transmit a connection information comprising connection information related to the AP to the IP camera 102 through the first connection CON1. After the IP camera 102 receives the connection information, the IP camera 102 may connect to the cloud server 104 through the AP, so as to check whether the electronic device 100 has registered the registration information RG related to the IP camera 102.

In Step 208, after the registration information RG of the electronic device is confirmed to be registered by the electronic device 100, the electronic device 100 displays the frame information FR. In an embodiment, after confirming that the electronic device 100 has registered the registration information RG in the cloud server 104, the cloud server 104 may send a permitted-to-display information PM to the electronic device 100. After the electronic device 100 receives the permitted-to-display information PM, the electronic device 100 is permitted to display the frame information FR which is previously received and stored by the electronic device 100 in Step 206. Then, installation of the network monitoring system 10 is completed.

According to the installation process 20, the IP camera 102 of the present invention may both transmit the frame information captured by the IP camera 102 through the first connection CON1 and connect to the cloud server 104 through the second connection CON2. In addition, the electronic device 100 may send the connection information, necessitated by the IP camera 102 to connect to the cloud server 104, to the IP camera 102 through the first connection CON1. In comparison to the prior art, there is no need for the IP camera 102 to switch between the AP mode and the Wi-Fi mode. Since the frame information FR captured by the IP camera 102 is transmitted to the electronic device 100 through the first connection CON1, the waiting time of the users is significantly reduced.

Notably, the embodiments stated above are utilized for illustrating concepts of the present invention. Those skilled in the art may make modifications and alternations accordingly, and not limited herein. For example, the electronic device 100 and the IP camera 102 are not limited to employ Wi-Fi Direct to establish the first connection CON1. As long as the first connection CON1 is established based upon any peer-to-peer wireless communication protocol, requirements of the present invention is satisfied, wherein the peer-to-peer wireless communication protocol is a communication protocol capable of performing wireless peer-to-peer transmission without passing through the AP (or a base station of the cellular system) in general.

In summary, the IP camera of the present invention may both transmit the frame information through the first connection established based upon the peer-to-peer wireless communication protocol, and connect to the cloud server through the second connection to perform registration confirmation. In addition, the electronic device may send the connection information, necessitated by the IP camera to connect to the cloud server, to the IP camera through the first connection. In addition, the frame information captured by the IP camera is transmitted directly to the electronic device through the first connection. In such a situation, the waiting time of the users is significantly reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An installation method, utilized in a network monitoring system, the installation method comprising:
an electronic device establishing a first connection with an internet protocol (IP) camera through a peer-to-peer wireless communication protocol;
the IP camera transmitting a frame information to the electronic device through the first connection and connecting to a cloud server through a second connection to check whether the electronic device registers a registration information related to the IP camera in the cloud server; and
the electronic device displaying the frame information after the registration information of the electronic device is confirmed to be registered.

2. The installation method of claim 1, wherein the peer-to-peer wireless communication protocol is a peer-to-peer wireless communication protocol within a wireless local area network (WLAN).

3. The installation method of claim 1, wherein the second connection for the IP camera connecting to the cloud server is through a WLAN.

4. The installation method of claim 1, further comprising:
the electronic device transmitting a connection information related to the second connection to the IP camera through the first connection.

5. A network monitoring system, comprising:
an electronic device; and
an internet protocol (IP) camera, wherein the IP camera is configured to establish a first connection with the electronic device through a peer-to-peer wireless communication protocol, transmit a frame information to the electronic device through the first connection, and connect to a cloud server through a second connection to check whether the electronic device registers a registration information related to the IP camera in the cloud server;
wherein the electronic device displays the frame information after the registration information of the electronic device is confirmed to be registered.

6. The network monitoring system of claim 5, wherein the peer-to-peer wireless communication protocol is a peer-to-peer wireless communication protocol within a wireless local area network (WLAN).

7. The network monitoring system of claim 5, wherein the second connection for the IP camera connecting to the cloud server is through a WLAN.

8. The network monitoring system of claim 5, wherein electronic device is further configured to perform the following step:
the electronic device transmitting a connection information related to the second connection to the IP camera through the first connection.
